(19) United States
(12) Patent Application Publication
(10) Pub. No.: US 2003/0120189 A1
(43) Pub. Date: Jun. 26, 2003

(54) Massage devices and methods

(76) Inventor: Josephine Chinea, Bronx, NY (US)

Correspondence Address: WHITE & CASE LLP, PATENT DEPARTMENT, 1155 AVENUE OF THE AMERICAS, NEW YORK, NY, 10036, US

(21) Appl. No.: 10/122,618

(22) Filed: Apr. 15, 2002

Related U.S. Application Data
(60) Provisional application No. 60/342,621, filed on Dec. 20, 2001.

(51) Int. Cl. A61H 15/02

(52) U.S. Cl. 601/137; 601/17

(57) ABSTRACT

The invention provides acupressure and messaging devices in the form of beads strung on a flexible cord sized and configured to be fitted about the human hand. The invention further relates to acupressure and massage methods which employ the device of the invention.

This application claims priority to U.S. Provisional Application Serial No. 60/342,621, filed Dec. 20, 2001, which is hereby incorporated by reference in its entirety.

### FIELD OF THE INVENTION

The present invention is directed to a massage device and method which can be self-applied or applied by others. The method employs a device in the form of a closed length of rotatable beads that are strung together. The closed length is designed to fit a user's hand.

### BACKGROUND OF THE INVENTION

Exercise or abnormal stress often creates a buildup of lactic acid in the muscles of the body. When this buildup occurs, there are often muscular aches or pains. These pains may often be eliminated or reduced by massaging the muscles thereby stimulating the circulation and purging the excess lactic acid from the muscles. Prior inventions have attempted to alleviate muscles pain in various ways. For example, the Mencher-Aliazzo Patent (U.S. Pat. No. 5,779,652) discloses a massage device that is comprised of a plurality of balls mounted on a flexible fibrous element. The device is then draped over a surface and the user's body weight is applied against this draped “curtain” of balls during the massage procedure. Another example is the Lewark Patent (U.S. Pat. No. 5,569,169). This patent discloses a flexible strand containing spaced nodules along its length. This strand may then be looped around various parts of the user's body. A static pressure is then applied to the strand. Another example is the Burnham Patent (U.S. Pat. No. 5,725,484) which describes a personal massager consisting of a pair of handles which are connected by a grid of filaments that supports a massage surface made up of beads strung on these filaments.

Each of the aforementioned devices is for massaging. However, each differs significantly from the device of the present application. The present invention is an advantageous improvement over the prior art methods and devices.

### SUMMARY OF THE INVENTION

The present invention relates to devices and methods for applying a massage. In particular, the invention provides an advantageous method of applying massage to muscles that are stressed, overworked and/or in pain. The device consists of a closed length of rotatable beads. The beads are strung together on and along a length of a flexible cord. The diameter of the beads is in the range of about 14 mm to about 20 mm. The diameter of the beads is the same along the length of the cord or, alternatively, the diameter may vary along the length of the cord.

In accordance with the method of the invention, the hand of the user is inserted into the device so that the beads encircle the pahn of the hand. The hand is then pressed against the desired muscles in such a way that a substantial number of the beads are located on the palm side of the hand. The user's hand presses and moves the device against and across the muscles in a substantially rotational direction. In this way, pressure is applied to the desired area of the body. The device may be self-applied or applied to a subject by others.

When the device is applied to the muscles of the face, the pressing and moving of the device proceeds from the lower facial area to the upper facial area. When the device is used on the body, the massage recipient may also stretch the muscles receiving the massage in order to enhance the effects of the massage.

The invention is also directed to a kit comprising the massaging device and, optionally, a container of massage oil.

### BRIEF DESCRIPTION OF THE DRAWINGS

FIG. 1 shows an embodiment of the massage device of the invention, wherein the device is fitted about the hand of user.

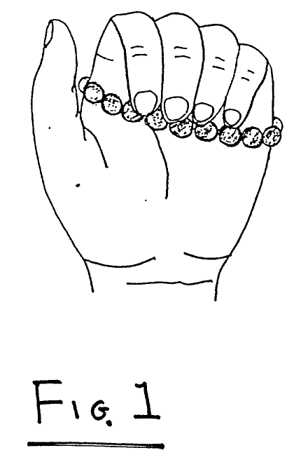

FIG. 2 shows an embodiment of the massage device of the invention, wherein the diameter of the beads is variable along the length of a flexible cord and wherein the cord is formed into a loop by a releasable connecting latch.

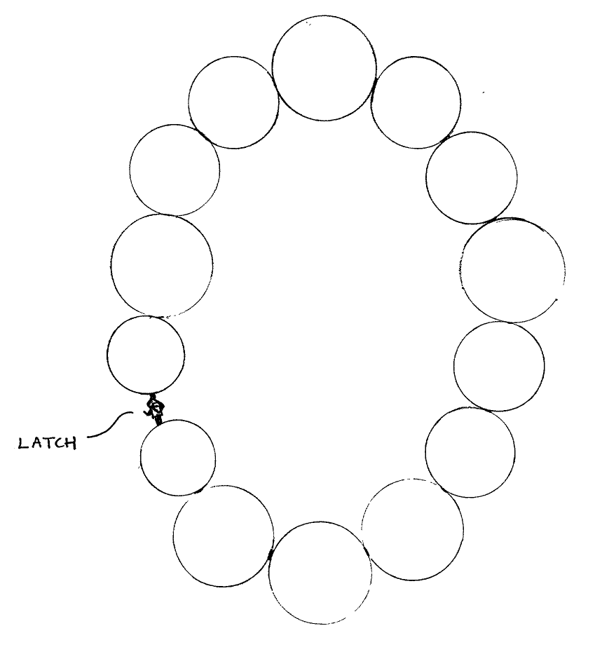

### DETAILED DESCRIPTION OF THE INVENTION

The present invention relates to methods of massaging muscles of the body and devices for applying massage and acupuncture pursuant to the method of the invention. The method employs a massage device comprising a closed length of a flexible material sized to fit a user's hand. In accordance with one embodiment, the closed length is a continuous length of a cord wherein the ends of the cord are melded together or otherwise designed to remain permanently closed. Alternatively, the closed length has releasably joining ends to form a closed loop configuration when the ends are joined. In accordance with this embodiment, the length has two configurations: an open configuration and a closed configuration. A releasable connecting element such as a latch or hook is attached or part of each end of the device in the open position. The connecting elements on each end of the device are releasably joined to configure the device into the closed configuration.

The length of the cord must be sufficient to support a plurality of rotatable beads and fit about the hand of the user. Any sort of natural or synthetic string, thread, rope, chain or any other suitable flexible material may be used as a material forming the cord. The flexible cord material may be formed by elastomeric fibers, such as elastomeric nylon, rubber-like materials, such as natural and synthetic art rubbers, plastics or any other flexible or elastomeric material known in the art which is suitable for threading the rotatable beads. A massage device comprising a length of an elastomeric material can be sized to expand, if necessary, so as to snuggly fit about the user's hand. Of course, the material should be sufficient to resist breakage during use.

In accordance with the invention, a plurality of rotatable beads are strung on the flexible length as to be adjacent to each other, forming a row, while remaining substantially rotatable with respect to the cord on which they are strung. The beads may be comprised of any solid material. The solid bead material may be entirely non-compliant as in the case of natural stone, glass, minerals, mineral crystals, and hard synthetic polymers. The solid bead material may also be selected to have predetermined degrees of compliance. Examples of such materials include but are not limited to natural rubbers and synthetic rubbers. Composite beads comprising a non-compliant core and a more complaint outer shell may also be used.

Beads of the same or varying size may be strung on the same cord. The size of the beads and the variability and configuration of the bead sizes can be selected to optimize the massage effects with respect to the age and size of a subject, the size of particular muscle groups for which massage is desired and the area to be massaged. In accordance with one embodiment, the beads have a diameter in the range of about 14 mm to about 20 mm. For example, approximately 16 beads having a diameter of approximately 20 mm may be strung on a closed length of a flexible cord. Alternatively, 6 beads having a diameter of about 16 mm and 6 beads having a diameter of about 20 mm are alternately strung on a cord. The beads of varying diameter may be strung in alternating fashion along the entire length of the cord or along a part of the length.

In accordance with the method of the invention, the device comprising a closed length or rotatable beads is placed around the hand of the user by inserting the hand within the closed loop of the device. The hand of the user is pressed against the desired muscles in such a way that a substantial number of the rotatable beads are located on the palm-side of the hand of the user. The hand is then pressed against the muscles while moving the device against and across the desired muscles in a rotational direction. In this fashion, the desired muscles are massaged, thereby relieving muscle stress and generally increasing the sense of well being of the individual receiving the massage. As used herein, the expression “pressing and moving the device” refers to bringing the device into contact with the tissue overlying the actual muscles so that pressure can be transmitted through the overlying tissue to the underlying muscle. Once the device is in contact with the skin, pressure is applied in a rotational direction such that the device travels over the skin. The device may be self-used or used by others applying the massage to another.

The method of the invention may be utilized on the facial muscles to relieve stress, improve the condition of the skin of the face and promote a more youthful appearance. When the method is utilized with the massaging device on the face, the motion of the device may be from the bottom of the face to the top of the face.

The massage technique may also be applied while the massage recipient performs stretching exercises and deep breathing, e.g., pranayama breathing. The specific stretching that may be performed by the massage recipient during the massage includes, but is not limited to, grasping a part of the subject's body, pushing the body part with a hand in one direction while resisting with the same body part in the opposite direction. The stretch position may be held for 30 seconds. The breathing exercises which may be performed while the stretching is performed include inhaling through the nose and exhaling through the mouth. Breathing and stretching during the massage will enhance relaxation and the therapeutic benefits of the massage.

In accordance with a further embodiment of the invention, the beads of the device are heated to above room temperature prior to contacting the beads with the muscles to be massaged. Any suitable form of heating may be used to heat the beads of the device such as but not limited to heating in an oven or under a heat lamp. Alternatively, the beads are heated by soaking them in a volume of heated massage oil. Advantageously, when the beads are removed from the heated oil, the beads will be coated with the oil and an amount of heated massage oil will be transferred on the beads to the muscle area(s) during the massage procedure.

The invention is also directed to a kit comprising the massage device of the invention and, optionally, at least one container capable of holding a volume of massage oil. The container may, for example, be in the form of a bottle, flask or squeeze tube.

The invention differs in significant ways from prior art methods and devices in the field of massage and acupressure. The device of the present invention is portable and may be self-used. Furthermore, the device is small in size and may also be applied to a subject by one or more users. Advantageously, the user may adjust the amount of pressure to be applied to the muscles by varying the pressure to be applied as well as the size of the beads.

The disclosure as set forth in the detailed description are for illustrative purposes and do not limit the scope of the invention.

What is claimed is:

1. A method of massaging muscles of the body, comprising the steps of:
(a) providing at least one flexible massaging device comprised of a closed length of rotatable beads strung together, wherein the device is sized and configured to be fitted about a user's hand;
(b) placing the device around the user's hand such that a substantial number of beads is located on the palm-side of the hand;
(c) placing the device in contact with the muscles of a subject; and
(d) pressing and moving the device against and across the muscles to apply pressure to the desired area of the body.

2. The method according to claim 1, wherein step (d) comprises pressing and moving the device against and across the muscles in a substantially rotational direction.

3. The method according to claim 1, wherein the application of pressure is self-applied.

4. The method according to claim 1, wherein the application of pressure is applied to the subject by one or more users.

5. The method according to claim 1, wherein the beads have a diameter in the range of about 14 mm to about 20 mm.

6. The method according to claim 1, wherein the diameter of the beads is the same.

7. The method according to claim 1, wherein the diameter of the beads is variable.

8. The method according to claim 1, wherein the muscles are facial muscles.

9. The method according to claim 8, wherein the device is moved in a direction proceeding from the lower facial area to the upper facial area.

10. The method according to claim 1, wherein the pressure is applied while simultaneously stretching the muscles.

11. The method according to claim 1, further comprising the step of heating the beads of the device prior to placing the beads of the device in contact with the muscles.

12. The method according to claim 8, wherein the step of heating the beads comprises incubating the beads in a volume of massage oil.

13. A massage device comprising a closed loop of flexible material on which beads are strung, wherein the closed loop is sized and configured to fit about a user's hand.

14. The massage device according to claim 13, wherein the material is elastomeric.

15. The massage device according to claim 13, wherein the beads have diameters in the range of about 14 mm to 20 mm.

16. The massage device according to claim 13, wherein the diameter of the beads is the same.

17. The massage device according to claim 13, wherein the diameter of the beads is variable

18. A massage device comprising,
(a) a flexible cord having a first end and a second end; and
(b) a connector at each end of the cord, the connectors of the first end and the second end being adapted for releasably joining the two ends so that the cord has a closed loop configuration when the ends are joined,
wherein rotatable beads are strung on the cord, and the cord is sized and configured to fit about a user's hand when the cord is in the closed loop configuration.

19. A massage kit comprising the massage device of claim 13 or 18.

20. The massage kit according to claim 19, further comprising at least one container capable of holding massage oil.
